(19) United States
(12) Patent Application Publication
(10) Pub. No.: US 2022/0364400 A1
(43) Pub. Date: Nov. 17, 2022

(54) CLOSURE LATCH ASSEMBLY WITH POWER CINCH MECHANISM HAVING ANTI-CHUCKING FUNCTION

(71) Applicant: Magna Closures Inc., Newmarket (CA)

(72) Inventor: Francesco CUMBO, Newmarket (CA)

(21) Appl. No.: 17/623,290

(22) PCT Filed: Jul. 7, 2020
(86) PCT No.: PCT/CA2020/050940

§ 371 Date: Dec. 28, 2021

Related U.S. Application Data
(60) Provisional application No. 62/871,553, filed on Jul. 8, 2019.

(51) Int. Cl. E05B 85/26; E05B 85/24; E05B 83/38; E05B 77/36

(52) U.S. Cl. CPC E05B 85/26; E05B 85/243; E05B 83/38; E05B 77/36

(57) ABSTRACT

A closure latch assembly for a dual-door closure system in a motor vehicle includes an anti-chucking mechanism and cinching mechanism in cooperation with a latch mechanism. The anti-chucking mechanism cooperates with the latch mechanism to provide an anti-chucking feature, while the cinching mechanism cooperates with the latch mechanism to provide a cinching feature, wherein an anti-chucking cancellation mechanism prevents interference of the anti-chucking mechanism with the cinching mechanism.

### CROSS-REFERENCE TO RELATED APPLICATION

This application claims the benefit of U.S. Provisional Application Ser. No. 62/871,553, filed Jul. 8, 2019, which is incorporated herein by reference in its entirety.

### FIELD

The present disclosure relates generally to door closure systems for motor vehicles. More specifically, the present disclosure relates to a vehicular closure latch assembly equipped with a power cinch function and an anti-chucking function.

### BACKGROUND

This section provides background information related to vehicular door closure systems and is not necessarily prior art to the inventive concepts associated with the present disclosure.

A typical motor vehicle is equipped with at least one pair of doors to provide access to a passenger compartment. Specifically, most vehicles include driver-side and passenger-side swing doors that are pivotably supported from the vehicle body to move between closed and open positions. These doors are each equipped with a latch assembly having a latch mechanism operable in a latched mode to hold the door in its closed position and in an unlatched mode to permit movement of the door to its open position. The latch assembly is also equipped with a latch release mechanism that is selectively actuated (manually via a handle-actuated release system and/or via a power-operated release system) to shift the latch mechanism into its unlatched mode.

Many vehicles are equipped with multiple side (i.e., front and rear) doors for access to the passenger compartment. Most commonly, when viewed from the front of the vehicle, the front and rear side doors are hinged proximate their front edge. The front doors are hinged to a front structural pillar (i.e., the A-pillar), while the rear doors are hinged to an intermediate structural pillar (i.e., the B-pillar), which is situated between the front and rear doors. The latch assemblies associated with the front doors are arranged to latch with a front striker fixed to the B-pillar. Likewise, the latch assemblies associated with the rear doors are arranged to latch with a rear striker fixed to a rearward sill portion of the opening. In some vehicles, such as pick-up trucks with extended cabs, the vehicle body is formed with an enlarged door opening without a structural B-pillar. Such “B-pillar-less” dual-door closure systems typically include a front swing door pivotably hinged along its front edge to the front vertical structural portion (i.e., the A-pillar), of the door opening and a rear swing door pivotably hinged along its rear edge to a rear vertical structural portion (i.e., the C-pillar), of the door opening. The absence of the intermediate structural pillar (i.e., the B-pillar), requires that the rear door must latch along at least one of upper and lower portions of the enlarged access opening while the front door must latch directly to the rear door. Typically, the latch assembly in the rear door cannot be unlatched until the front door latch assembly has been released and the front door swung to its open position.

A great deal of development has been directed to latching systems for such dual-door B-pillar-less closure arrangements. One recognized issue requiring corrective action is the elimination of door rattle or “chucking” noise that is generated at the latched interface between the front and rear doors during motive operation of the motor vehicle. Most commonly, this chucking noise is generated due to movement between the ratchet associated with the latch mechanism in the door latch assembly and the door-mounted striker, and in particular, movement of the ratchet to an over-travel position beyond a fully latched, striker capture position. One known anti-chucking solution has employed a rubber bumper mounted to the striker to eliminate the chucking movement of the striker relative to the ratchet via a “wedging” function. However, high release effort, as well as high latching effort, are required to overcome this resilient wedging function. Another anti-chucking solution has been employed to prevent movement of the ratchet beyond the fully latched, striker capture position. However, preventing the movement of the ratchet beyond the fully latched, striker capture position may interfere with the ability the latching system to be cinched via movement of the ratchet to the over-travel position, as desired, during a cinching operation.

Accordingly, a recognized need exists to address and overcome known drawbacks for B-pillar-less door systems by providing an anti-chucking solution in association with the latch assembly without impeding the ability of the latch mechanism to function as intended, including a desired cinching operation.

### SUMMARY

This section provides a general summary of the present disclosure and is not intended to be considered a comprehensive and exhaustive listing of its full scope or all aspects, objectives and features.

It is an aspect of the present disclosure to provide a closure latch assembly for a vehicular door closure system having a power cinch function and an anti-chucking function.

It is a related aspect of the present disclosure to provide the closure latch assembly having the power cinch function and an anti-chucking function for use in a dual-door vehicular closure system.

It is another related aspect of the present disclosure to provide the closure latch assembly with a latch mechanism, a cinching mechanism and an anti-chucking mechanism arranged to work cooperatively to provide the cinching and anti-chucking functions.

In accordance with these and other aspects, the present disclosure provides a closure latch assembly for a motor vehicle closure system having a door moveable between open and closed positions relative to a striker. The closure latch assembly includes a latch mechanism having a ratchet moveable between a striker release position, a striker capture position, and a striker over-travel position, and a pawl moveable between a ratchet holding position, whereat the pawl holds the ratchet in its striker capture position, and a ratchet releasing position, whereat the pawl permits the ratchet to move to its striker release position. The closure latch assembly further includes an anti-chucking mechanism having an anti-chuck lever moveable between a released position and an engaged position, and a cinch mechanism having a cinch lever moveable between an unactuated position and an actuated position. Further yet, the closure latch assembly includes a cancellation lever moveable between a disengaged position and an engaged position, wherein, while the cancellation lever is in its disengaged position, the anti-chuck lever is operable to move from its released position to its engaged position to inhibit movement of the ratchet from its striker capture position toward its striker over-travel position, and wherein, while the cancellation lever is in its engaged position, the cancellation lever inhibits movement of the anti-chuck lever from its released position to its engaged position, thereby allowing the cinch lever to move from its unactuated position to its actuated position to move the ratchet to its striker over-travel position.

In accordance with another aspect, the closure latch assembly further includes a latch release mechanism operable for moving the pawl from its ratchet holding position to its ratchet releasing position, wherein movement of the pawl from its ratchet holding position to its ratchet releasing position causes corresponding movement of the ratchet in a ratchet releasing direction from its striker capture position to its ratchet releasing position and movement of the anti-chuck lever from its engaged position to its released position.

In accordance with another aspect, movement of the door from its open position to its closed position causes the striker to engage the ratchet and forcibly move the ratchet in a ratchet closing direction from its striker release position to its striker over-travel position, wherein movement of the ratchet into its striker over-travel position permits the pawl to move from its ratchet releasing position into its ratchet holding position. Movement of the pawl to its ratchet holding position permits the anti-chuck lever to move from its released position into its engaged position while the cancellation lever remains in its disengaged position.

In accordance with another aspect, the cancellation lever is biased toward its disengaged position by a cancellation spring member, thereby automatically permitting the anti-chuck lever to move from its released position into its engaged position when desired.

In accordance with another aspect, the cinch lever engages the cancellation lever as the cinch lever moves from its unactuated position toward its actuated position and causes the cancellation lever to move against a bias of the cancellation spring member from its disengaged position to its engaged position.

In accordance with another aspect, the cinch lever disengages the cancellation lever as the cinch lever moves from its actuated position toward its unactuated position, whereupon the cancellation lever is automatically caused to move under the bias of the cancellation spring member from its engaged position to its disengaged position.

In accordance with another aspect, the cinch lever is biased toward its unactuated position by a cinch lever spring and a ratchet spring biases the ratchet in the ratchet releasing direction from its striker over-travel position into its striker capture position such that a pawl latch lug on the pawl engages a latch shoulder on the ratchet for holding the ratchet in its striker capture position when the pawl is located in its ratchet holding position to inhibit movement of the ratchet in the ratchet releasing direction, wherein a latched engagement interface between the ratchet and the anti-chuck lever inhibits movement of the ratchet in the ratchet closing direction from its striker capture position toward its striker over-travel position to provide an anti-chucking feature.

In accordance with another aspect, the latched engagement interface can be provided by a stop lug on the ratchet engaging a lever latch shoulder on the anti-chuck lever.

In accordance with another aspect, while the cancellation lever is in its engaged position, a blocking engagement interface between the cancellation lever and the anti-chuck lever inhibits movement of the anti-chuck lever from its released position to its engaged position.

In accordance with another aspect, the ratchet and the cancellation lever can be supported for rotation about a common axis, thereby simplifying and ensuing coordinated movement therebetween.

In accordance with another aspect, the ratchet and the cancellation lever can be supported for rotation about different axes, thereby providing design flexibility and decoupled movement therebetween, thus, eliminating potential frictional engagement therebetween.

In accordance with another aspect, a closure latch assembly for a motor vehicle closure system having a door moveable between open and closed positions is provided. The closure latch assembly includes a latch mechanism having a ratchet moveable between a striker release position, a striker capture position, and a striker over-travel position; a ratchet spring biasing the ratchet toward its striker release position, and a pawl moveable between a ratchet holding position, for holding the ratchet in its striker capture position, and a ratchet releasing position, for permitting the ratchet to move to its striker release position. A pawl spring can be provided for biasing the pawl toward its ratchet holding position. The closure latch assembly further includes a latch release mechanism that is operable for moving the pawl from its ratchet holding position into its ratchet releasing position; an anti-chucking mechanism having an anti-chuck lever moveable between a released position and an engaged position, and an anti-chuck lever spring for biasing the anti-chuck lever toward its engaged position. Further yet, the closure latch assembly includes a cinch mechanism having a cinch lever moveable between an unactuated position and an actuated position, wherein a cinch spring can be provided for biasing the cinch lever toward its unactuated position. Additionally, the closure latch assembly includes a cancellation lever moveable between a disengaged position and an engaged position, wherein a cancellation spring can be provided for biasing the cancellation lever toward its disengaged position. While the cancellation lever is in its disengaged position, the anti-chuck lever is operable to move to its engaged position to engage the ratchet to inhibit movement of the ratchet from its striker capture position toward its striker over-travel position. While the cancellation lever is in its engaged position, the cancellation lever is operable to inhibit movement of the anti-chuck lever to its engaged position, thereby allowing the cinch lever to move to its actuated position to move the ratchet to its striker over-travel position.

The closure latch assembly of the present disclosure is also configured such that movement of the pawl from its ratchet holding position to its ratchet releasing position in response to actuation of the latch release mechanism causes corresponding movement of the anti-chuck lever from its engaged position to its released position.

The closure latch assembly of the present disclosure is also configured such that movement of the door from its open position to its closed position causes a striker to engage the ratchet and forcibly move the ratchet in the closing direction from its striker release position to its striker over-travel position. Movement of the ratchet into its striker over-travel position permits the pawl to move from its ratchet releasing position into its ratchet holding position, and movement of the pawl to its ratchet holding position permits the anti-chuck lever spring to move the anti-chuck lever from its released position into its engaged position.

The closure latch assembly of the present disclosure is also configured such that an engagement interface is established between the ratchet and the anti-chuck lever when the anti-chuck lever is located in its engaged position. The engagement interface inhibits movement of the ratchet in the closing direction from its striker capture position to its striker over-travel position.

The closure latch assembly of the present disclosure can be configured such that the engagement interface is defined by a stop lug on the ratchet engaging a lever latch shoulder on the anti-chuck lever. Alternatively, the engagement interface can be defined by a lever latch lug formed on the anti-chuck lever that is retained within a latching notch formed in the ratchet.

The closure latch assembly of the present disclosure is further configured such that the ratchet spring forcibly moves the ratchet in the releasing direction from its striker over-travel position into its striker capture position whereat a pawl latch lug on the pawl engages a latch shoulder on the ratchet for holding the ratchet in its striker capture position when the pawl is located in its ratchet holding position so as to inhibit movement of the ratchet in the releasing direction. As noted, the engagement interface between the ratchet and the anti-chuck lever inhibits movement of the ratchet in its closing direction. As a result, engagement of the ratchet with both of the pawl and the anti-chuck lever in its striker capture position provides the anti-chucking feature.

The closure latch assembly of the present disclosure is configured such that the anti-chucking feature functions to retain the striker in a striker retention seat formed in the ratchet and to resist a striker push-out force acting in the releasing direction and a striker push-in force acting in the closing direction.

The closure latch assembly of the present disclosure is configured such that the striker can be fixed to a rear door of a dual-door closure system and the closure latch assembly can be fixed to a front door of the dual-door closure system.

The closure latch assembly of the present disclosure is configured for use in a B-pillar-less dual-door closure system, wherein the dual-door closure system includes a front door and a rear door, wherein the striker can be fixed to one of the rear door or the front door, and the closure latch assembly can be fixed to the other of the front door or the rear door.

The closure latch assembly of the present disclosure is configured for use in a B-pillar-less dual-door closure system, wherein the dual-door closure system includes a front door and a rear door, wherein the closure latch assemblies can be fixed along or proximate upper and lower surfaces of the front door or the rear door, wherein at least one of the closure latch assemblies, and preferably an upper closure latch assembly, or both of the closure latch assemblies, have an anti-chucking feature that functions to retain the striker in a striker retention seat formed in the ratchet and to resist a striker push-out force acting in the releasing direction and a striker push-in force acting in the closing direction.

In accordance with another aspect, a method of preventing an anti-chucking mechanism of a closure latch assembly from interfering with the movement of a ratchet to a striker over-travel position while cinching the closure latch assembly to move a closure panel of a motor vehicle from an open position to a closed position is provided. The method includes providing the ratchet being moveable between a striker release position, a striker capture position, and the striker over-travel position. Further, providing the anti-chucking mechanism having an anti-chuck lever moveable between a released position, whereat the ratchet can move to the striker over-travel position, and an engaged position, whereat the ratchet is inhibited from moving to the striker over-travel position. Further yet, providing a cinch mechanism having a cinch lever moveable between an unactuated position, whereat the ratchet remains in one of its striker release position and striker capture position, and an actuated position, whereat the ratchet is moved to its striker over-travel position. Further, providing a cancellation lever moveable from a disengaged position, whereat the anti-chuck lever is operable to move from its released position to its engaged position to inhibit movement of the ratchet from its striker capture position toward its striker over-travel position, to an engaged position, whereat the cancellation lever maintains the anti-chuck lever in its released position to allow the ratchet to move to its striker over-travel position. And, causing the cancellation lever to move from its disengaged position to its engaged position as the cinch lever moves from its unactuated position to its actuated position.

In accordance with another aspect, the method can further include automatically causing the cancellation lever to move from its disengaged position to its engaged position while cinching the closure latch assembly.

In accordance with another aspect, the method can further include causing the cinch lever to engage the cancellation lever as the cinch lever is moving from its unactuated position to its actuated position, with the engagement causing the cancellation lever to move from its disengaged position to its engaged position.

In accordance with another aspect, the method can further include automatically causing the cancellation lever to move from its engaged position to its disengaged position upon completing the cinching of the closure latch assembly.

In accordance with another aspect, the method can further include biasing the cancellation lever with a cancellation lever spring to move from its engaged position to its disengaged position.

In accordance with another aspect, the method can further include biasing the anti-chuck lever with an anti-chuck lever spring to move from its released position to its engaged position.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a motor vehicle equipped with a pillar-less dual-door closure system;

FIG. 2 is a side elevation view of a portion of the motor vehicle shown in FIG. 1 with the doors of the dual-door closure system located in a closed position;

FIG. 3 is a side isometric view of a portion of the motor vehicle shown in FIG. 1 with the doors of the dual-door closure system located in a partially open position;

FIG. 4 is an isometric view of a closure latch assembly for use with at least one of the doors of the dual-door closure system and which is configured to provide anti-chucking and cinching functions in accordance with the present disclosure;

FIG. 4A is a side elevation view of the closure latch assembly of FIG. 4 shown with a ratchet of the closure latch assembly in a secondary striker capture position;

FIG. 4B is an opposite side elevation view of FIG. 4A;

FIG. 5 is a view similar to FIG. 4 showing the ratchet in the secondary striker capture position, a cinch lever in an unactuated position, a cancellation lever in a disengaged position, and an anti-chuck lever in a disengaged position;

FIG. 5A is side elevation view of a portion of FIG. 5 showing the cinch lever initiating engagement with the ratchet;

FIG. 6 is a view similar to FIG. 5 showing the ratchet in an intermediate position between the secondary striker capture position and the striker over-travel position, the cinch lever in an intermediate position between the unactuated position and an actuated position, the cancellation lever in the disengaged position, and the anti-chuck lever in the disengaged position;

FIG. 6A is a side elevation view of FIG. 6 showing the ratchet being rotated by the cinch lever and the pawl being rotated by the ratchet;

FIG. 7 is a view similar to FIG. 6 showing the ratchet in an intermediate position between the secondary striker capture position and the striker over-travel position, the cinch lever in an intermediate position between the unactuated position and an actuated position, the cancellation lever in an engaged position, and the anti-chuck lever in the disengaged position;

FIG. 7A is a side elevation view of FIG. 7 showing the ratchet being rotated by the cinch lever and the pawl being rotated by the ratchet;

FIG. 8 is a view similar to FIG. 7 showing the ratchet in the striker over-travel position, the cinch lever in the actuated position, the cancellation lever in the engaged position shown blocking the anti-chuck lever and maintaining the anti-chuck lever in the disengaged position;

FIG. 8A is a side elevation view of FIG. 8 showing the ratchet rotated by the cinch lever to the striker over-travel position and the cancellation lever engaged with and blocking the anti-chuck lever in the disengaged position;

FIG. 9 is a view similar to FIG. 8 showing the ratchet returned to a primary striker capture position via a bias imparted by a ratchet spring, the cinch lever returned to the unactuated position via a bias imparted by a cinch lever spring, the cancellation lever returned to the disengaged position via a bias imparted by a cancellation lever spring, and the anti-chuck lever in the disengaged position just prior to being returned to an engaged position via a bias imparted by an anti-chuck lever spring;

FIG. 10 is a view similar to FIG. 9 showing the ratchet in the primary striker capture position, the cinch lever in the unactuated position, the cancellation lever in the disengaged position, and the anti-chuck lever returned to an engaged position via the anti-chuck lever spring to inhibit the ratchet from moving toward the striker over-travel position;

FIG. 10A is a side elevation view of FIG. 10 showing the anti-chuck lever engaging a stop lug segment of the ratchet to inhibit the ratchet from moving toward the striker over-travel position;

FIG. 11 is an isometric view of a closure latch assembly for use with at least one of the doors of the dual-door closure system and which is configured to provide anti-chucking and cinching functions in accordance with another aspect of the present disclosure showing a ratchet in the secondary striker capture position, a cinch lever in an unactuated position, a cancellation lever in a disengaged position, and an anti-chuck lever in a disengaged position;

FIG. 11A is a side elevation view of the closure latch assembly of FIG. 11;

FIG. 12 is a view similar to FIG. 11 showing the ratchet in an intermediate position between the secondary striker capture position and the striker over-travel position, the cinch lever in an intermediate position between the unactuated position and an actuated position, the cancellation lever in the disengaged position, and the anti-chuck lever in the disengaged position;

FIG. 12A is a side elevation view of FIG. 12 showing the ratchet being rotated by the cinch lever and the pawl being rotated by the ratchet;

FIG. 13 is a view similar to FIG. 12 showing the ratchet in an intermediate position between the secondary striker capture position and the striker over-travel position, the cinch lever in an intermediate position between the unactuated position and an actuated position, the cancellation lever in an engaged position, and the anti-chuck lever in the disengaged position;

FIG. 13A is a side elevation view of FIG. 13 showing the ratchet being rotated by the cinch lever and the pawl being rotated by the ratchet;

FIG. 14 is a view similar to FIG. 13 showing the ratchet in the striker over-travel position, the cinch lever in the actuated position, the cancellation lever in the engaged position shown blocking the anti-chuck lever and maintaining the anti-chuck lever in the disengaged position;

FIG. 14A is a side elevation view of FIG. 14 showing the ratchet rotated by the cinch lever to the striker over-travel position and the cancellation lever engaged with and blocking the anti-chuck lever in the disengaged position;

FIG. 15 is a view similar to FIG. 14 showing the ratchet returned to a primary striker capture position via a bias imparted by a ratchet spring, the cinch lever returned to the unactuated position via a bias imparted by a cinch lever spring, the cancellation lever returned to the disengaged position via a bias imparted by a cancellation lever spring, and the anti-chuck lever in the disengaged position just prior to being returned to an engaged position via a bias imparted by an anti-chuck lever spring;

FIG. 15A is a side elevation view of FIG. 15;

FIG. 16 is a view similar to FIG. 15 showing the ratchet in the primary striker capture position, the cinch lever in the unactuated position, the cancellation lever in the disengaged position, and the anti-chuck lever returned to an engaged position via the anti-chuck lever spring to inhibit the ratchet from moving toward the striker over-travel position;

FIG. 16A is a side elevation view of FIG. 16 showing the anti-chuck lever engaging a stop lug segment of the ratchet to inhibit the ratchet from moving toward the striker over-travel position; and

FIG. 17 is a flow diagram illustrating a method of preventing an anti-chucking mechanism of a closure latch assembly from interfering with the movement of a ratchet to a striker over-travel position while cinching the closure latch assembly to secure a closure panel of a motor vehicle in a closed position.

### DETAILED DESCRIPTION OF EXAMPLE EMBODIMENTS

Example embodiments of a closure latch assembly configured to include a latch mechanism; an anti-chucking mechanism; a cinch mechanism; and a cancellation lever will now be more fully described with reference to the accompanying drawings. These example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

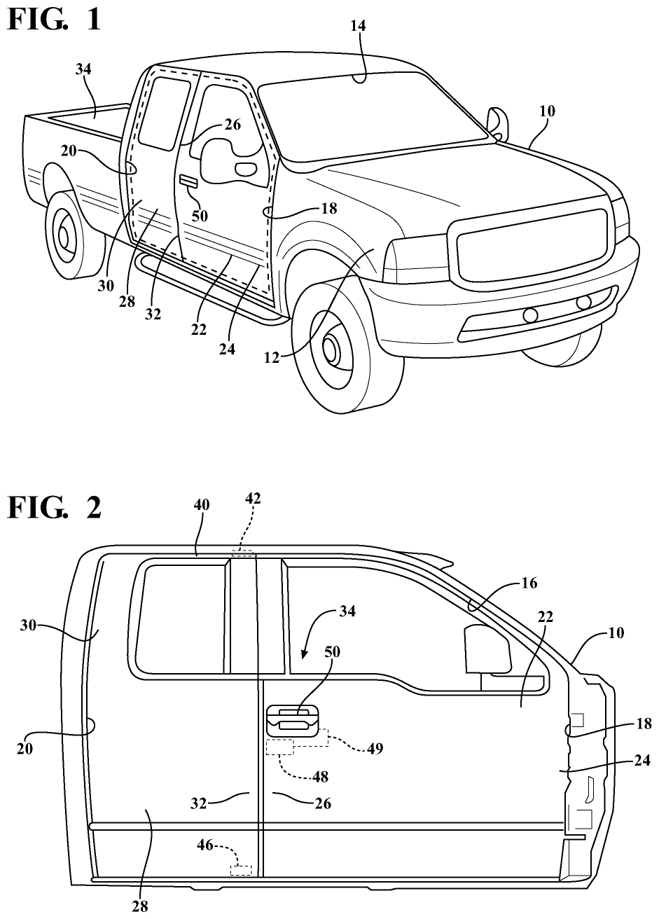

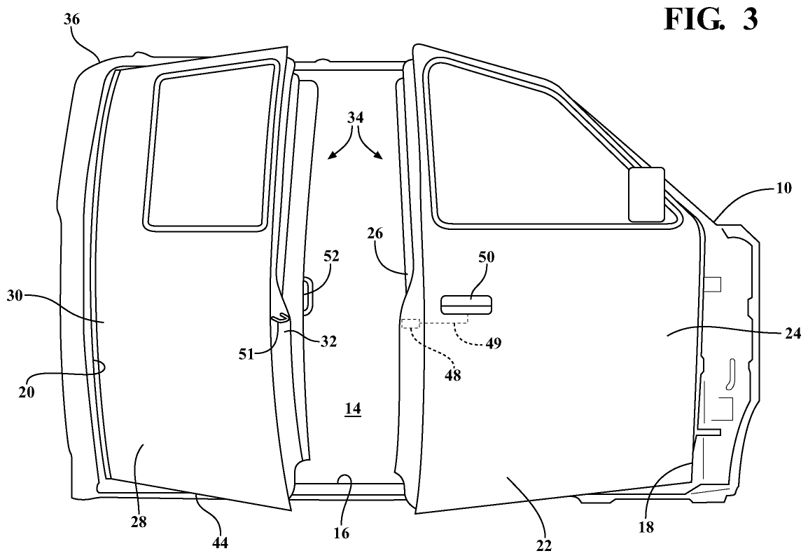

Referring initially to FIGS. 1-3, a motor vehicle is shown configured as a pickup truck including a vehicle body 10 having an exterior 12 and an interior 14 defining a passenger compartment. Connecting exterior 12 and interior 14 of vehicle body 10 is a continuous or “pillar-less” side opening 16 (FIG. 3) defining a first or front terminal end 18 and a second or rear terminal end 20, with there being no pillar, commonly referred to as a “B-pillar” extending between the front and rear terminal ends 18, 20. Accordingly, opening 16 is “B-pillar-less.” Providing a first moveable closure panel, also referred to as closure member, for a front portion of opening 16 is a first or front door 22 having a forward portion 24 pivotably connected via front hinges (not shown), wherein front hinges are connected to an “A-pillar” of vehicle body 10 adjacent to front terminal end 18 of opening 16. Front door 22 has a rearward portion 26 generally opposite its pivotal connection to vehicle body 10. Providing a second moveable closure panel or closure member for a rear portion of opening 16 is a second or rear door 28. Rear door 28 has a rearward portion 30 which is pivotably connected via rear hinges (not shown), wherein rear hinges are connected to a “C-pillar” of vehicle body 10 adjacent to rear terminal end 20 of opening 16 and has a forward portion 32 generally opposite to its pivotal connection. When front door 22 and rear door 28 are closed together, the extreme end of rearward portion 26 of front door 22 overlaps and is operably latched to and/or directly latched to the extreme end of forward portion 32 of rear door 28. Accordingly, front door 22 and rear door 28 together define a B-pillar-less, dual-door motor vehicle closure arrangement, also referred to as motor vehicle closure system 34.

Rear door 28 is schematically shown along its upper edge 40 to have a releasable latched connection via an upper or first closure latch assembly 42 (FIG. 2) with vehicle body 10 at a location between front and rear terminal ends 18 and 20 of opening 16. Rear door 28 is also schematically shown along a bottom edge 44 to have a releasable latched connection via a lower or second closure latch assembly 46 with vehicle body 10 at a location between front and rear terminal ends 18 and 20 of opening 16. When closed, front door 22 has a releasable latched connection via an intermediate (between upper and lower latch assemblies 42, 46) or third closure latch assembly 48 with rear door 28. Third closure latch assembly 48 is shifted from a latched mode into an unlatched mode via actuation of a latch actuation mechanism 49 associated with a front door handle 50. The latch actuation mechanism 49 may be manually-operated and/or power-operated to facilitate the release of third closure latch assembly 48. A release handle 52 (FIG. 3) is provided on an interior wall along forward portion 32 of rear door 28 and can be actuated, with front door 22 open, to concurrently shift each of first closure latch assembly 42 and second closure latch assembly 46 from its latched mode into its unlatched mode to permit rear door 28 to pivot outwardly toward its open position.

Those skilled in the art will recognize that the particular location of first and second closure latch assemblies 42, 46 and third closure latch assembly 48 shown in FIGS. 1-3 is merely intended to illustrate one exemplary dual-door latching arrangement and is not intended to limit the present disclosure, as it will be recognized that other arrangements are possible, and considered to be within the scope of the present disclosure. The third closure latch assembly, referred to hereafter simply as closure latch assembly 48, described herein may also be employed in single door latching arrangements, where the closure latch assembly 48 is arranged on a vehicle door and operable to releasably latch a striker fixed to the rearward sill of the vehicle body 10 or a pillar (e.g. B-pillar) adjacent to the door, as opposed to a striker 51 fixed to the edge portion of rear door 28 as illustrated in FIGS. 1-3. Further the closure latch assembly 48 may be employed in other automotive latching configurations, such as a hook latch, a side door latch, a cargo door latch, a decklid latch, a glass latch, a sliding door latch, an auxiliary latch, an emergency release latch, a seat latch, a liftgate latch, a tailgate latch, and the like. Likewise, the type of latch release mechanism employed is not relevant to the inventive concepts associated with the anti-chucking/cinching aspects of the present disclosure and those skilled in the art will appreciate that any known power and/or manual latch release mechanism can be associated with each of the closure latch assemblies. Dual-door systems may also include sliding door systems, tailgate systems, access hatch systems, or other ingress/egress systems.

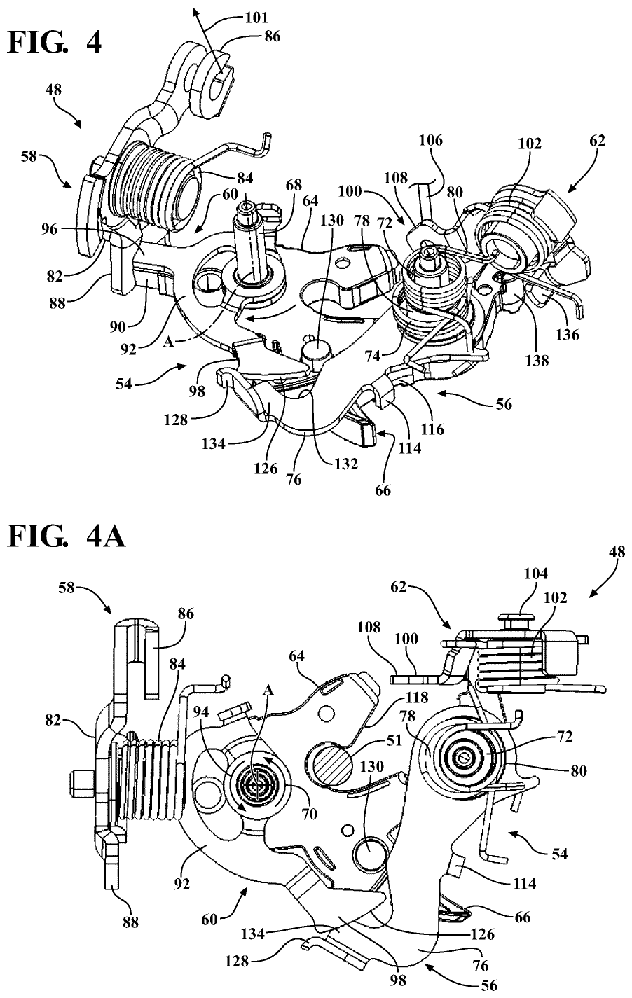

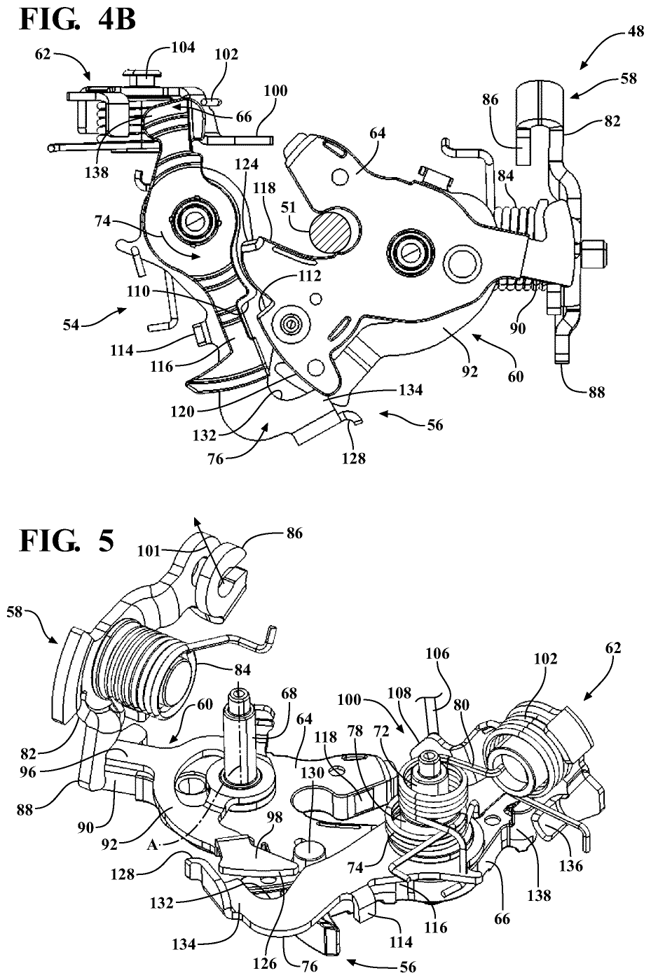

Referring now to FIGS. 4-4B, various components of a non-limiting embodiment of a closure latch assembly in accordance with an aspect of the disclosure will be described to clearly indicate integration of an anti-chucking and cinching feature/mechanism, with temporary anti-chucking cancellation feature/mechanism, into a latch mechanism for the purpose of eliminating door rattle noise, commonly referred to as “chucking” noise, between front door 22 and rear door 28 such as may occur while the motor vehicle is being driven via the anti-chucking feature, while allowing the front door 22 to be cinched from an at least partially open position to a fully closed position via the cinching feature, without interference from the anti-chucking feature. It is to be understood that the closure latch assembly hereinafter described can be used with rear door 28 and/or front door 22 in any one or more of the upper, lower and/or intermediate latch assembly positions. FIG. 4 illustrates the closure latch assembly of the present disclosure as third closure latch assembly 48, by way of example and without limitation, which is mounted to a portion of front door 22. Closure latch assembly 48 is operable to releasably latch to the striker 51 fixed to the edge portion of rear door 28.

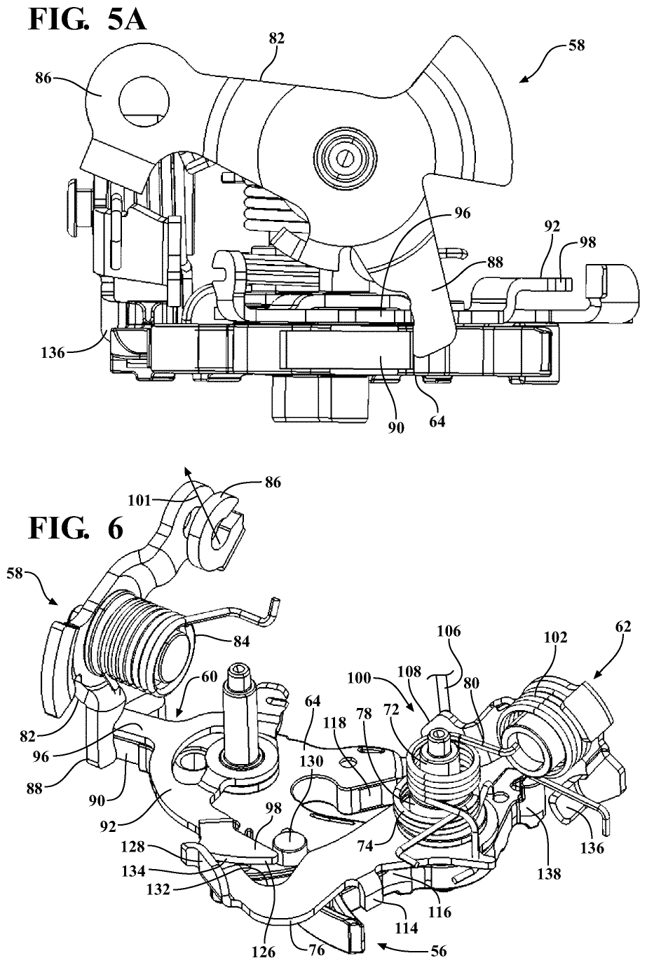

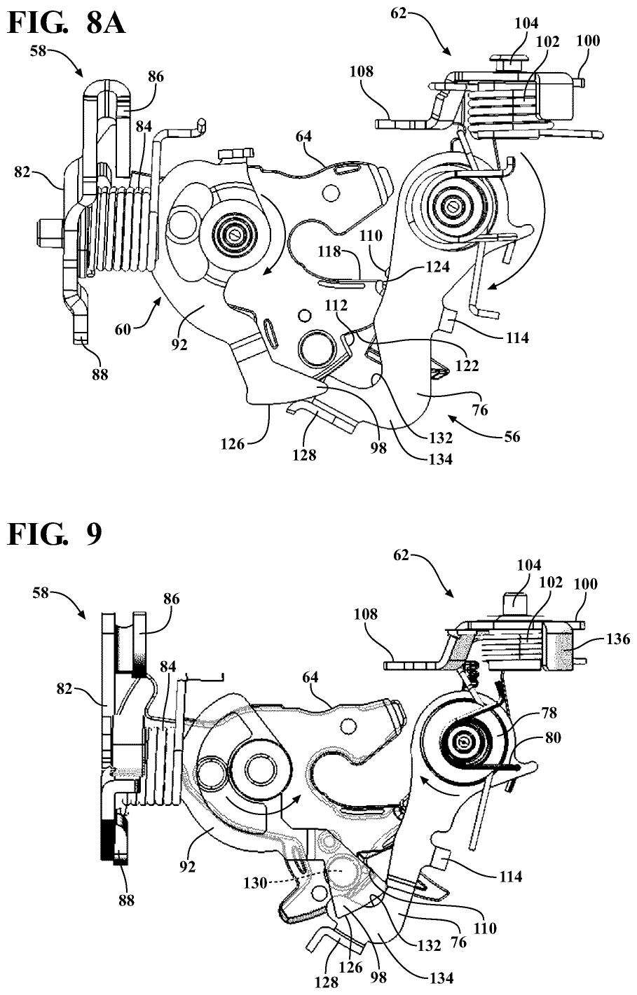

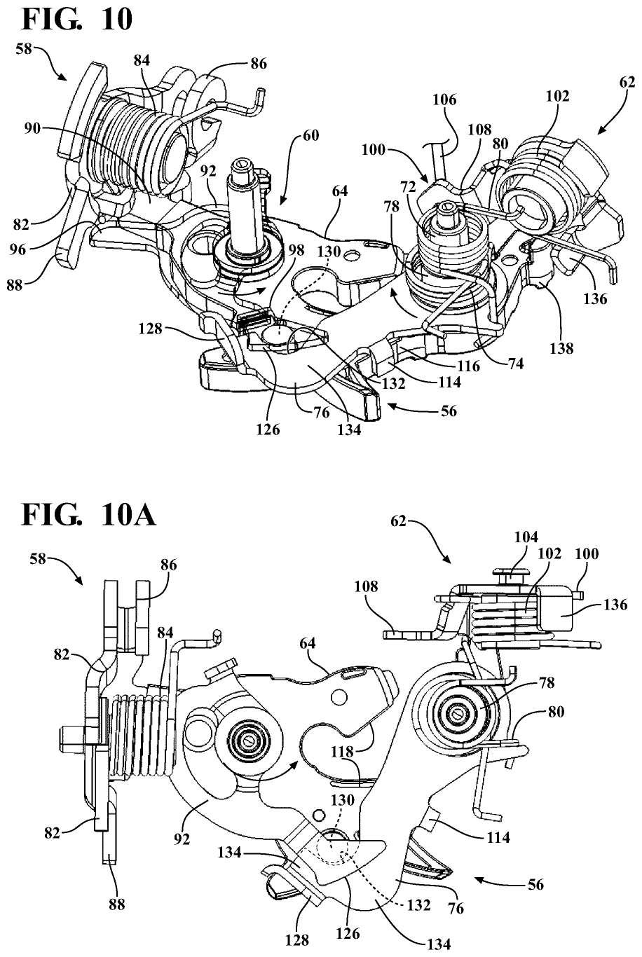

Closure latch assembly 48 includes a latch mechanism 54, an anti-chucking mechanism 56, a cinch mechanism 58, an anti-chucking cancellation mechanism 60, and a latch release mechanism 62. Latch mechanism 54 includes a ratchet 64 and a pawl 66. Ratchet 64 is pivotably supported on a frame plate via a ratchet rivet 68 for rotation about an axis A between a striker release position, a secondary striker capture position (FIGS. 4, 4A, 5, 5A), a primary striker capture position (FIGS. 9, 10, 10A), and a striker over-travel position (FIGS. 8, 8A). Ratchet 64 is normally biased toward its striker release position via a ratchet spring shown schematically at 70 (FIG. 4A). Pawl 66 is pivotably supported on frame plate via a pawl rivet 72 for movement relative to ratchet 64 between a ratchet holding position and a ratchet releasing position. Pawl 66 is normally biased toward its ratchet holding position via a pawl spring 74.

Anti-chucking mechanism 56 generally includes an anti-chuck lever 76, an anti-chuck washer 78, and an anti-chuck lever spring 80. Anti-chuck lever 76 is pivotably supported, such as via pawl rivet 72 also supporting pawl 66 for pivotal movement, by way of example and without limitation, for pivoting movement between a released position, also referred to as disengaged position, and an engaged position. Anti-chuck lever spring 80 is operable to normally bias anti-chuck lever 76 toward its engaged position.

Cinch mechanism 58 generally includes a cinch lever 82 and a cinch lever spring 84. Cinch lever 82 has an actuator arm 86 configured for operable communication with an actuation member, such as via a cable or rod, wherein actuation member can be mechanically, electromechanically and/or electronically actuatable, for example by an actuator 101 having an electric motor. Cinch lever 82 also has a drive arm 88 configured for selective driving engagement with a ratchet cinch arm, also referred to as driven member, ear or cog 90, of ratchet 64. Cinch lever spring 84 is operable to normally bias cinch lever 82 clockwise (as viewed in FIG. 4) toward an unactuated position.

Anti-chucking cancellation mechanism 60 generally includes an anti-chucking cancellation lever, referred to hereafter as cancellation lever 92, and a cancellation lever spring shown schematically at 94 (FIG. 4A). Cancellation lever 92 is pivotably supported, such as on ratchet rivet 68, for movement between a disengaged position, also referred to as rest position, and an engaged position, also referred to as holding position. Cancellation lever 92 has an actuator arm, also referred to as driven arm 96, configured for selective engagement with drive arm 88 of cinch lever 82 and a blocking arm 98 configured for selective engagement with anti-chucking lever 76. Cancellation lever spring 94 is operable to normally bias cancellation lever 92 counterclockwise (as viewed in FIG. 4) toward the disengaged position.

Latch release mechanism 62 is shown to generally include a release lever 100 and a release lever spring 102. Release lever 100 is pivotably mounted on a release lever rivet 104 for movement between a non-actuated position and an actuated position. Release lever spring 102 is configured to normally bias release lever 100 toward its non-actuated position. Release cable 106 is adapted to be interconnected between a first lug segment 108 of release lever 100 and door handle 50 so as to permit release lever 100 to move from its non-actuated position to its actuated position in response to actuation of door handle 50.

Referring now to FIGS. 5-8A, a series of sequential views are provided to illustrate a cinching operation of closure latch assembly 48. In particular, FIGS. 5 and 5A show closure latch assembly 48 in a partially opened and partially closed state, anti-chucking mechanism 56 in a released, disengaged position, cinch lever 82 in a pre-travel state, whereat actuation of a cinch actuator (not shown) is initiated to start to pivot cinch lever 82, cancellation lever 92 is in the rest or disengaged position, and latch release mechanism 62 in a non-actuated state. Specifically, ratchet 64 is shown in its secondary striker capture position (striker 51 mounted to rear door 28 is not shown), pawl 66 is shown (FIG. 4B) held in its secondary locked position via engagement of a pawl latch lug 110 with a secondary latch shoulder 112 formed on ratchet 64, anti-chuck lever 76 is shown held in its released position via engagement of a generally L or hook-shaped lever lug segment 114 formed on anti-chuck lever 76 with a first elongated leg portion 116 of pawl 66. The aforementioned states/positions are caused via movement of front door 22 from its open position toward its closed position, whereupon striker 51 is caused to enter a fishmouth segment of a latch housing frame plate (not shown) and engage a guide channel 118 formed in ratchet 64, thereby forcibly pivoting ratchet 64 in a closing (i.e., counterclockwise as viewed in FIG. 4B) direction from its striker release position toward its primary striker capture position in opposition to the biasing of ratchet spring 70. Such action causes pawl latch lug 110 to continue to ride along a first ratchet cam surface 120 on ratchet 164 so as to continue to hold pawl 66 in its ratchet releasing position. As noted, when pawl 66 is held in its ratchet releasing position, anti-chuck lever 76 is retained and held in its released position via engagement of lever lug segment 114 with elongated leg portion 116 of pawl 66.

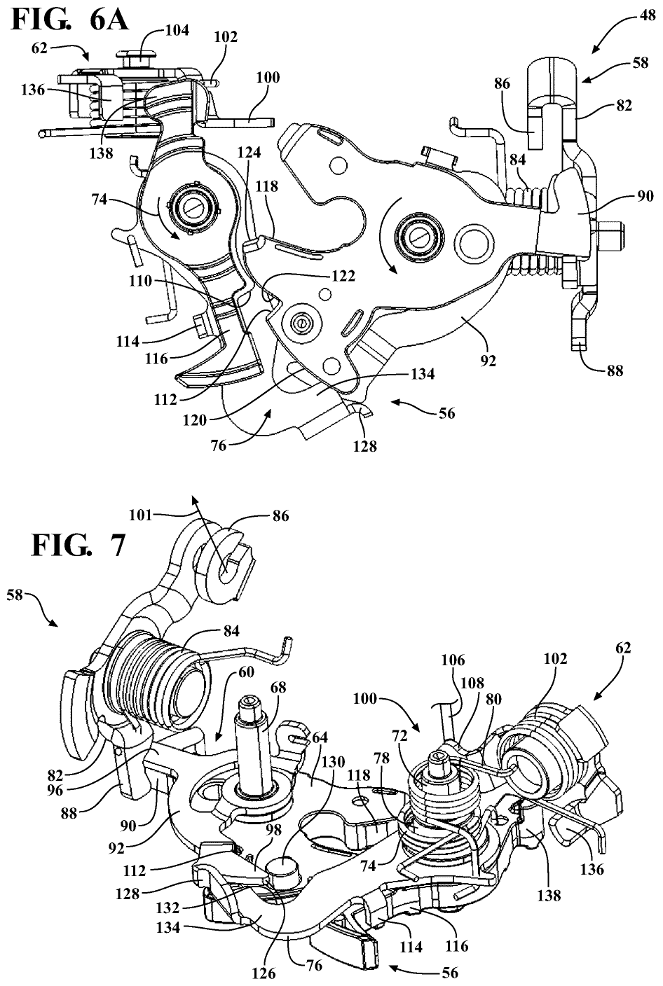

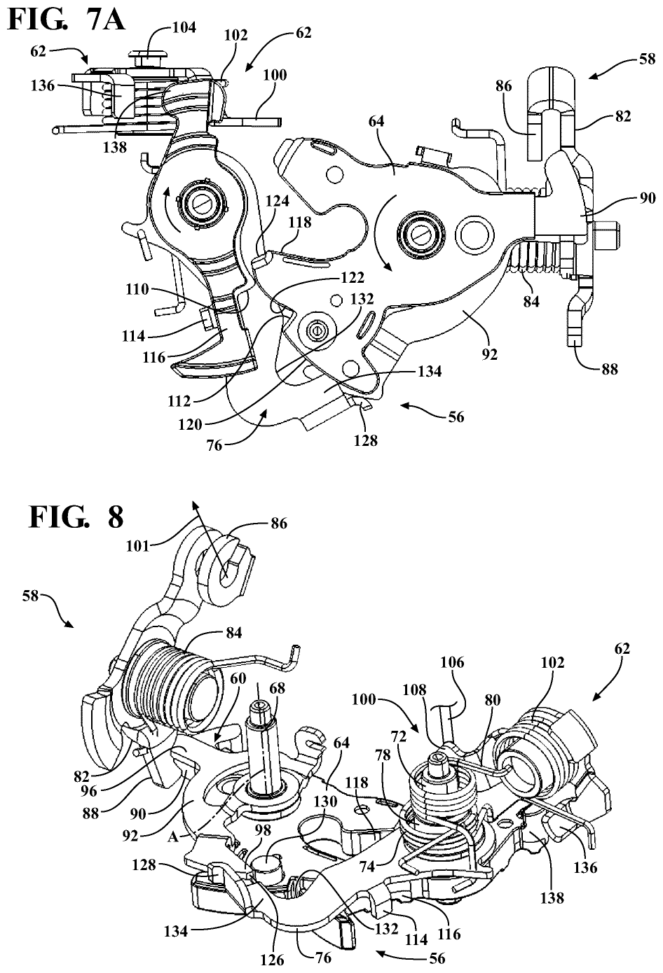

Referring next to FIG. 6, continued actuation and rotation of the cinch lever 82 causes continued rotation of ratchet 64 in the closing direction from the secondary striker capture position toward the over-travel position, whereupon pawl latch lug 110 rides along a second ratchet cam surface 122 formed on ratchet 64, whereat drive arm 88 of cinch lever 82 initiates engagement with actuator arm 96 of cancellation lever 92 (shown in rest, disengaged position in FIG. 6). Then, as cinch lever 82 continues to rotate, drive arm 88 pushes actuator arm 96 and pivots cancellation lever 92 against the bias of cancellation lever spring 94 to a holding or engaged position, also referred to as the blocking position (FIG. 7). In the blocking position, an abutment portion, also referred to as stop surface 126, of blocking arm 98 of cancellation lever 92 is brought into position to confront a projection 128 of anti-chuck lever 76 (projection 128 is shown extending laterally outwardly from a generally planar surface of anti-chuck lever 76) to obstruct movement of anti-chuck lever 76 under the bias of anti-chuck lever spring 80. As such, anti-chuck lever 76 is temporarily restrained against movement to its engaged position. As a result, as shown in FIG. 8, ratchet 64 moves past its primary striker capture position into its striker over-travel position, such as due to front door 22 being moved to its fully closed (i.e., a “hard slam”) position. This rotation of ratchet 64 to its striker over-travel position permits pawl spring 74 to forcibly move pawl 66 into its ratchet holding position relative to ratchet 64. However, such over-travel of ratchet 64 does not result in completed latching engagement between pawl latch lug 110 and primary latch shoulder 124. FIG. 9 illustrates subsequent slight rotation of ratchet 64 in a releasing (i.e. counterclockwise) direction caused by ratchet spring 70 which, in turn, causes pawl latch lug 110 to engage primary latch shoulder 124 of ratchet 64, thereby causing pawl 66, while in its primary ratchet holding position, to hold ratchet 64 in its primary striker capture position. In this position, latch mechanism 54 is operating in its latched mode.

Thereafter, as shown in FIG. 10, cancellation lever 92 is caused to move back to its rest, disengaged position under the bias of cancellation lever spring 94, thereby allowing anti-chuck lever spring 80 to forcibly pivot anti-chuck lever 76 in the engaging direction until a raised stop feature, also referred to as anti-chucking pin, stop lug segment or simply stop lug 130, on ratchet 64 is retained in engagement against an anti-chuck latch shoulder 132 formed in generally hook-shaped end segment 134 of anti-chuck lever 76. This biased, confronting engagement between stop lug 130 and anti-chuck latch shoulder 132 establishes an engagement interface between ratchet 64 and anti-chuck lever 76. Thus, anti-chuck lever 76 is now located in its engaged position such that anti-chucking mechanism 56 is operating in its engaged mode, whereat ratchet 64 is prevented from pivoting from its primary striker capture position toward its striker over-travel position, thereby preventing the generation of chucking noise. To subsequently shift closure latch assembly 48 from its latched mode into its unlatched mode, release cable 106 pulls on release lever 100 for causing release lever 100 to move from its non-actuated position into its actuated position. Such pivotal movement of release lever 100 causes in a tab segment 136 on release lever 100 to engage a second leg portion 138 of pawl 66, wherein second leg portion 138 is located on an opposite side of pawl rivet 72 from first leg portion 116, for causing pawl 66 to forcibly move from its ratchet holding position into its ratchet releasing position, thereby permitting ratchet 64 to rotate from its primary striker capture position (FIG. 10A) back to its striker release position. As is understood, a power actuator, such as an electric motor and gearset, could be used to pivot release lever 100 from its non-actuated position into its actuated position to provide a power latch release feature. As pawl 66 rotates toward its ratchet releasing position, a drive surface of first elongate leg portion 116 engages lever lug segment 114 of anti-chuck lever 76 to pivot anti-chuck lever 76 to its released position. Anti-chuck lever 76 remains positioned in its released position as long as ratchet 64 remains in positions other than its primary striker capture position, due to engagement of lever lug segment 114 with elongate leg portion 116 of pawl 66, thereby allowing cancellation lever 92 to pivot to its engaged position, as discussed above, while a cinching operation is being performed to move ratchet 64 to its over-travel position while closing front door 22.

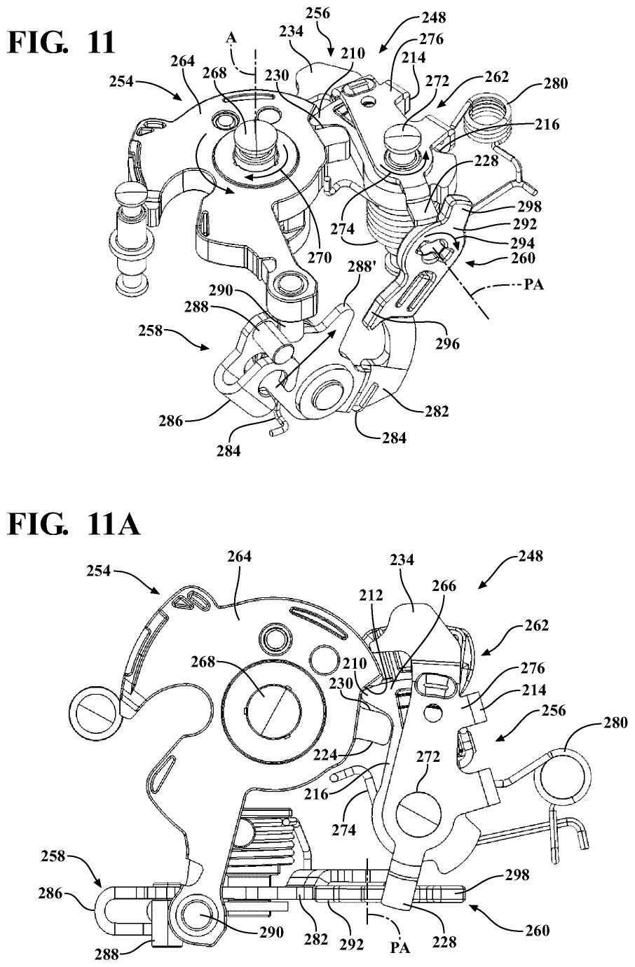

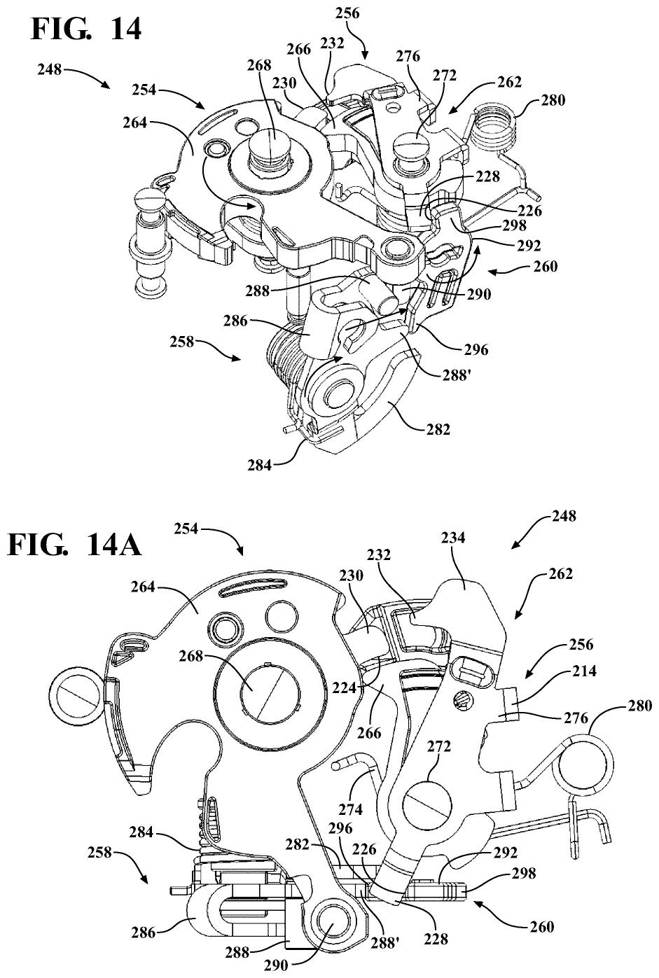

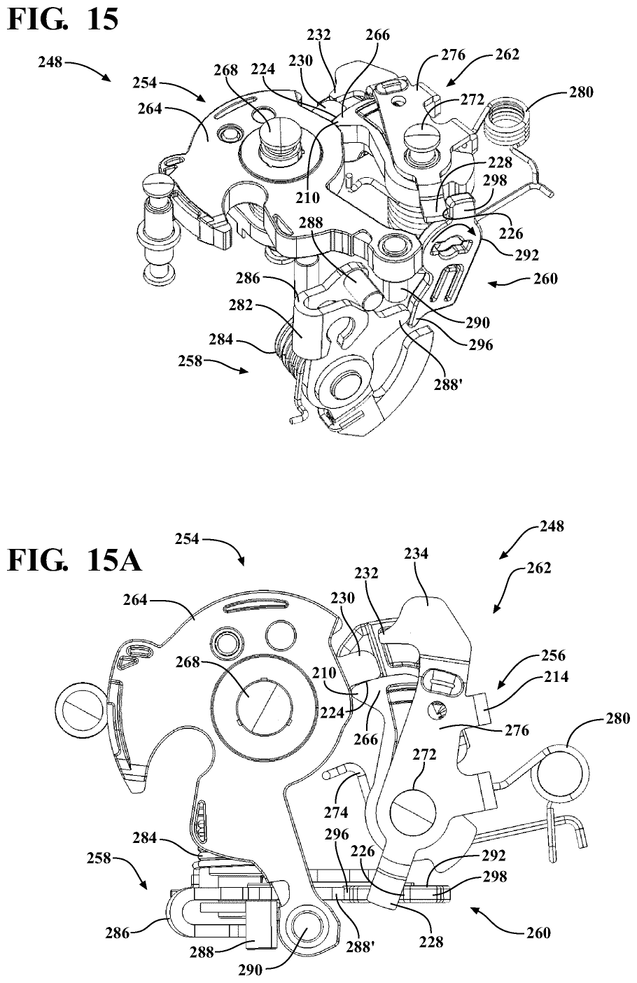

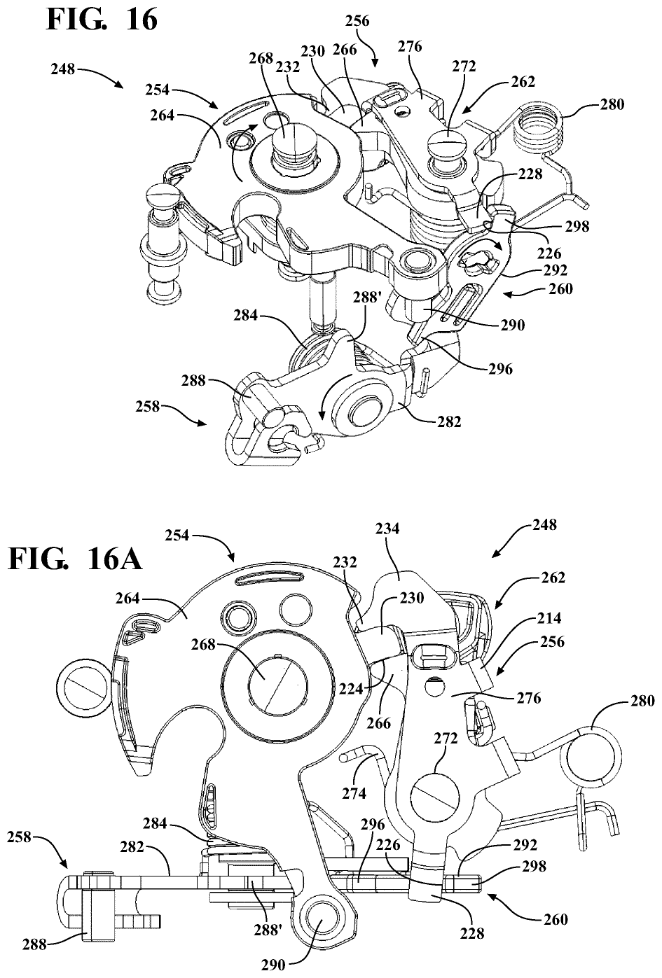

In FIGS. 11-16, a closure latch assembly 248 constructed in accordance with another aspect of the disclosure is illustrated, wherein the same reference numerals, offset by a factor of 200, are used to identify like features. Closure latch assembly 248 includes a latch mechanism 254, an anti-chucking mechanism 256, a cinch mechanism 258, an anti-chucking cancellation mechanism 260, and a latch release mechanism 262. Latch mechanism 254 includes a ratchet 264 and a pawl 266. Ratchet 264 is pivotably supported on a frame plate via a ratchet rivet 268 for rotation about an axis A (FIG. 11) between a striker release position, a secondary striker capture position (FIG. 11), a primary striker capture position (FIGS. 15 and 16), and a striker over-travel position (FIG. 14). Ratchet 264 is normally biased toward its striker release position via a ratchet spring shown schematically at 270 (FIG. 11). Pawl 266 is pivotably supported on frame plate via a pawl rivet 272 for movement relative to ratchet 264 between a ratchet holding position and a ratchet releasing position. Pawl 266 is normally biased toward its ratchet holding position via a pawl spring 274.

Anti-chucking mechanism 256 generally includes an anti-chuck lever 276 and an anti-chuck lever spring 280. Anti-chuck lever 276 is pivotably supported, such as via pawl rivet 272 also supporting pawl 266 for pivotal movement, by way of example and without limitation, for pivoting movement between a released position, also referred to as disengaged position, and an engaged position. Anti-chuck lever spring 280 is operable to normally bias anti-chuck lever 276 toward its engaged position.

Cinch mechanism 258 generally includes a cinch lever 282 and a cinch lever spring 284. Cinch lever 282 has an actuator arm 286 configured for operable communication with an actuation member, such as via a cable or rod, wherein actuation member can be mechanically, electromechanically and/or electronically actuatable, for example by an actuator, such as discussed above for actuator 101, having an electric motor. Cinch lever 282 also has a drive member, such as discussed above for drive arm, shown as a drive pine 288, configured for selective driving engagement with a ratchet cinch arm, also referred to as driven member, ear, cog or pin 290, of ratchet 264. Drive pin 288 and pin 290 are shown extending in generally transverse relation to one another, for selective engage with one another, as discussed above for drive arm 88 and cog 90. Cinch lever spring 284 is operable to normally bias cinch lever 282 toward an unactuated position.

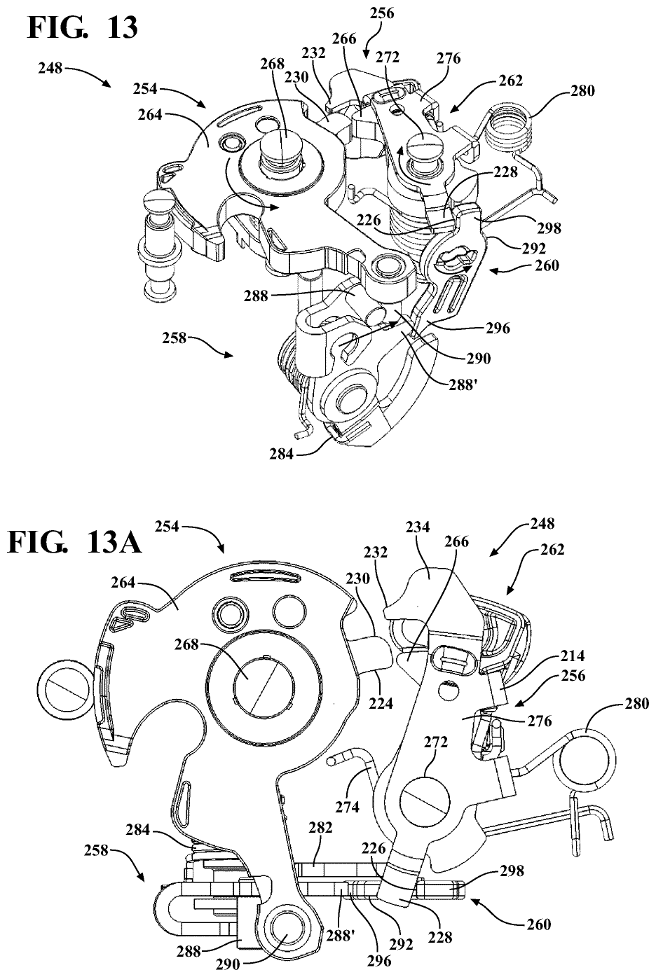

Anti-chucking cancellation mechanism 260 generally includes an anti-chucking cancellation lever, referred to hereafter as cancellation lever 292, and a cancellation lever spring shown schematically at 294 (FIG. 11). Cancellation lever 292 is pivotably supported for movement between a disengaged position, also referred to as rest position (FIGS. 11-12 and 15-16), and an engaged position, also referred to as holding position (FIGS. 13-14). In contrast to cancellation lever 92 discussed above, cancellation lever 292 is not pivotably supported by ratchet rivet 268, but rather, is supported for pivotal movement about a different axis, shown as a pivot axis PA (FIGS. 11 and 11A) extending generally transversely to the rotational axis A of ratchet rivet 268. Cancellation lever 292 has an actuator arm, also referred to as driven arm 296, configured for selective engagement with a drive arm 288′ of cinch lever 282 and a blocking arm 298 configured for selective engagement with a projection 228 of anti-chucking lever 276. Cancellation lever spring 294 is operable to normally bias cancellation lever 292 counterclockwise (as viewed in FIG. 11A) toward the disengaged position.

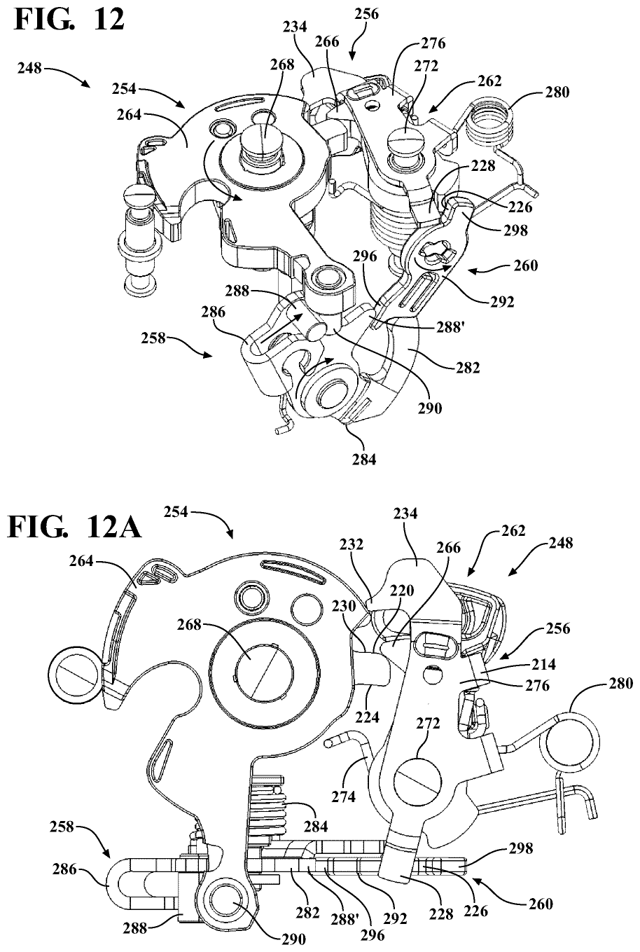

Referring now to FIGS. 11-16, as with FIGS. 5-10, a series of sequential views are provided to illustrate a cinching operation of closure latch assembly 248. In particular, FIGS. 11 and 11A show closure latch assembly 248 in a partially opened and partially closed state, anti-chucking mechanism 256 in a released, disengaged position, cinch lever 282 in a pre-travel state, whereat actuation of a cinch actuator (not shown) is initiated to start to pivot cinch lever 282, cancellation lever 292 is in the rest or disengaged position, and latch release mechanism 262 in a non-actuated state. Specifically, ratchet 264 is shown in its secondary striker capture position, pawl 266 is shown (FIG. 11A) held in its secondary locked position via engagement of a pawl latch lug 210 with a secondary latch shoulder 212 formed on ratchet 264, anti-chuck lever 276 is shown held in its released position via engagement of a generally L or hook-shaped lever lug segment 214 formed on anti-chuck lever 276 with a first elongated leg portion 216 of pawl 266. The aforementioned states/positions are caused, as discussed above, via movement of front door 22 from its open position toward its closed position. Such action causes pawl latch lug 210 to continue to ride along a first ratchet cam surface 220 (FIG. 12A) on ratchet 264 so as to continue to hold pawl 266 in its ratchet releasing position. As noted, when pawl 266 is held in its ratchet releasing position, anti-chuck lever 276 is retained and held in its released position via engagement of lever lug segment 214 with elongated leg portion 216 of pawl 266.

Referring next to FIG. 12, continued actuation and rotation of the cinch lever 282 causes continued rotation of ratchet 264 in the closing direction from the secondary striker capture position toward the over-travel position via engagement of drive pin 288 with pin 290, whereat drive arm 288′ of cinch lever 282 initiates engagement with actuator arm 296 of cancellation lever 292 (shown in rest, disengaged position in FIG. 12). Then, as cinch lever 282 continues to rotate, drive arm 288′ pushes actuator arm 296 and pivots cancellation lever 92 against the bias of cancellation lever spring 294 to a holding or engaged position, also referred to as the blocking position (FIGS. 13 and 14). In the blocking position, an abutment portion, also referred to as stop surface 226, of blocking arm 298 of cancellation lever 292 is brought into position to confront the projection 228 of anti-chuck lever 276 (projection 228 is shown extending laterally outwardly from a generally planar surface of anti-chuck lever 276) to obstruct movement of anti-chuck lever 276 under the bias of anti-chuck lever spring 280. As such, anti-chuck lever 276 is temporarily restrained against movement to its engaged position. As a result, as shown in FIGS. 14 and 14A, ratchet 264 moves past its primary striker capture position into its striker over-travel position, such as due to front door 22 being moved to its fully closed (i.e., a “hard slam”) position. This rotation of ratchet 264 to its striker over-travel position permits pawl spring 274 to forcibly move pawl 266 into its ratchet holding position relative to ratchet 264. However, such over-travel of ratchet 264 does not result in completed latching engagement between pawl latch lug 210 and primary latch shoulder 224. FIGS. 15 and 15A illustrate subsequent slight rotation of ratchet 264 in a releasing (i.e. counterclockwise) direction caused by ratchet spring 270 which, in turn, causes pawl latch lug 210 to engage primary latch shoulder 224 of ratchet 264, thereby causing pawl 266, while in its primary ratchet holding position, to hold ratchet 264 in its primary striker capture position. In this position, latch mechanism 254 is operating in its latched mode.

Thereafter, as shown in FIGS. 16 and 16A, cancellation lever 292 is caused to move back to its rest, disengaged position under the bias of cancellation lever spring 294, thereby allowing anti-chuck lever spring 280 to forcibly pivot anti-chuck lever 276 in the engaging direction until a raised stop feature, also referred to as anti-chucking pin, stop lug segment or simply stop lug 230, on ratchet 264 is retained in engagement against an anti-chuck latch shoulder 232 formed in generally hook-shaped end segment 234 of anti-chuck lever 276. This biased, confronting engagement between stop lug 230 and anti-chuck latch shoulder 232 establishes an engagement interface between ratchet 264 and anti-chuck lever 276. Thus, anti-chuck lever 276 is now located in its engaged position such that anti-chucking mechanism 256 is operating in its engaged mode, whereat ratchet 264 is prevented from pivoting from its primary striker capture position toward its striker over-travel position, thereby preventing the generation of chucking noise.

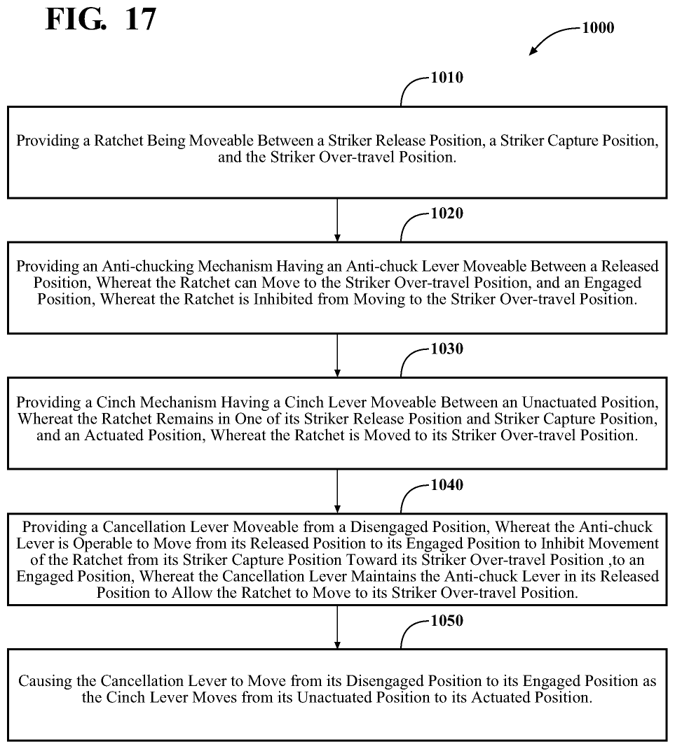

In accordance with another aspect of the disclosure, as illustrated at 1000 in FIG. 17, a method of preventing an anti-chucking mechanism 56, 256 of a closure latch assembly 48, 248 from interfering with the movement of a ratchet 64, 264 to a striker over-travel position while cinching the closure latch assembly 48, 248 to move a closure panel 22 of a motor vehicle from an open position to a closed position is provided. The method 1000 includes a step 1010 of providing the ratchet 64, 264 being moveable between a striker release position, a striker capture position, and the striker over-travel position. Further, a step 1020 of providing the anti-chucking mechanism 56, 256 having an anti-chuck lever 76, 276 moveable between a released position, whereat the ratchet 64, 264 can move to the striker over-travel position, and an engaged position, whereat the ratchet 64, 264 is inhibited from moving to the striker over-travel position. Further yet, a step 1030 of providing a cinch mechanism 58, 258 having a cinch lever 82, 282 moveable between an unactuated position, whereat the ratchet 64, 264 remains in one of its striker release position and striker capture position, and an actuated position, whereat the ratchet 64, 264 is moved to its striker over-travel position. Further, a step 1040 of providing a cancellation lever 92, 292 moveable from a disengaged position, whereat the anti-chuck lever 76, 276 is operable to move from its released position to its engaged position to inhibit movement of the ratchet 64, 264 from its striker capture position toward its striker over-travel position, to an engaged position, whereat the cancellation lever 92, 292 maintains the anti-chuck lever 76, 276 in its released position to allow the ratchet 64, 264 to move to its striker over-travel position. And, a step 1050 including causing the cancellation lever 92, 292 to move from its disengaged position to its engaged position as the cinch lever 82, 282 moves from its unactuated position to its actuated position.

In accordance with another aspect, the method 1000 can further include automatically causing the cancellation lever 92, 292 to move from its disengaged position to its engaged position while cinching the closure latch assembly 48.

In accordance with another aspect, the method 1000 can further include causing the cinch lever 82, 282 to engage the cancellation lever 92, 292 as the cinch lever 82, 282 is moving from its unactuated position to its actuated position, with the engagement causing the cancellation lever 92, 292 to move from its disengaged position to its engaged position.

In accordance with another aspect, the method 1000 can further include automatically causing the cancellation lever 92, 292 to move from its engaged position to its disengaged position upon completing the cinching of the closure latch assembly 48, 248.

In accordance with another aspect, the method 1000 can further include biasing the cancellation lever 92, 292 with a cancellation lever spring 94, 294 to move from its engaged position to its disengaged position.

In accordance with another aspect, the method 1000 can further include biasing the anti-chuck lever 76, 276 with an anti-chuck lever spring 80, 280 to move from its released position to its engaged position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a motor vehicle closure system having a door moveable between open and closed positions relative to a striker, the closure latch assembly comprising:
a latch mechanism having a ratchet moveable between a striker release position, a striker capture position, and a striker over-travel position, a pawl moveable between a ratchet holding position, whereat the pawl holds the ratchet in its striker capture position, and a ratchet releasing position, whereat the pawl permits the ratchet to move to its striker release position;
an anti-chucking mechanism having an anti-chuck lever moveable between a released position and an engaged position;
a cinch mechanism having a cinch lever moveable between an unactuated position and an actuated position; and
an anti-chucking cancellation mechanism having a cancellation lever moveable between a disengaged position and an engaged position,
wherein, while the cancellation lever is in its disengaged position, the anti-chuck lever is operable to move from its released position to its engaged position to inhibit movement of the ratchet from its striker capture position toward its striker over-travel position, and wherein, while the cancellation lever is in its engaged position, the cancellation lever inhibits movement of the anti-chuck lever from its released position to its engaged position, thereby allowing the cinch lever to move from its unactuated position to its actuated position to move the ratchet to its striker over-travel position.

2. The closure latch assembly of claim 1, further comprising a latch release mechanism operable for moving the pawl from its ratchet holding position to its ratchet releasing position, wherein movement of the pawl from its ratchet holding position to its ratchet releasing position causes corresponding movement of the ratchet in a ratchet releasing direction from its striker capture position to its ratchet releasing position and movement of the anti-chuck lever from its engaged position to its released position.

3. The closure latch assembly of claim 1, wherein movement of the door from its open position to its closed position causes the striker to engage the ratchet and forcibly move the ratchet in a ratchet closing direction from its striker release position to its striker over-travel position, wherein movement of the ratchet into its striker over-travel position permits the pawl to move from its ratchet releasing position into its ratchet holding position, and wherein movement of the pawl to its ratchet holding position permits the anti-chuck lever to move from its released position into its engaged position while the cancellation lever remains in its disengaged position.

4. The closure latch assembly of claim 1, wherein the cancellation lever is biased toward its disengaged position by a cancellation lever spring.

5. The closure latch assembly of claim 4, wherein the cinch lever engages the cancellation lever as the cinch lever moves from its unactuated position toward its actuated position and causes the cancellation lever to move against a bias of the cancellation lever spring from its disengaged position to its engaged position.

6. The closure latch assembly of claim 5, wherein the cinch lever disengages the cancellation lever as the cinch lever moves from its actuated position toward its unactuated position, whereupon the cancellation lever is caused to move under the bias of the cancellation lever spring from its engaged position to its disengaged position.

7. The closure latch assembly of claim 6, wherein the cinch lever is biased toward its unactuated position by a cinch lever spring and a ratchet spring biases the ratchet in the ratchet releasing direction from its striker over-travel position into its striker capture position such that a pawl latch lug on the pawl engages a latch shoulder on the ratchet for holding the ratchet in its striker capture position when the pawl is located in its ratchet holding position to inhibit movement of the ratchet in the ratchet releasing direction, wherein a latched engagement interface between the ratchet and the anti-chuck lever inhibits movement of the ratchet in the ratchet closing direction from its striker capture position toward its striker over-travel position to provide an anti-chucking feature.

8. The closure latch assembly of claim 7, wherein the latched engagement interface is defined by a stop lug on the ratchet engaging an anti-chuck latch shoulder on the anti-chuck lever.

9. The closure latch assembly of claim 1, wherein, while the cancellation lever is in its engaged position, a blocking engagement interface between the cancellation lever and the anti-chuck lever inhibits movement of the anti-chuck lever from its released position to its engaged position.

10. The closure latch assembly of claim 1, wherein the ratchet and the cancellation lever are supported for rotation about a common axis (A).

11. A method of preventing an anti-chucking mechanism of a closure latch assembly from interfering with the movement of a ratchet to a striker over-travel position while cinching the closure latch assembly to move a closure panel of a motor vehicle from an open position to a closed position, comprising:
providing the ratchet being moveable between a striker release position, a striker capture position, and the striker over-travel position;
providing the anti-chucking mechanism having an anti-chuck lever moveable between a released position, whereat the ratchet can move to the striker over-travel position, and an engaged position, whereat the ratchet is inhibited from moving to the striker over-travel position;
providing a cinch mechanism having a cinch lever moveable between an unactuated position, whereat the ratchet remains in one of its striker release position and striker capture position, and an actuated position, whereat the is moved to its striker over-travel position; and
providing a cancellation lever moveable from a disengaged position, whereat the anti-chuck lever is operable to move from its released position to its engaged position to inhibit movement of the ratchet from its striker capture position toward its striker over-travel position, to an engaged position, whereat the cancellation lever maintains the anti-chuck lever in its released position to allow the ratchet to move to its striker over-travel position.
